(19) United States
(12) Patent Application Publication
(10) Pub. No.: US 2024/0234981 A9
(43) Pub. Date: Jul. 11, 2024

(54) CYLINDRICAL BATTERY

(71) Applicant: MURATA MANUFACTURING CO., LTD., Kyoto (JP)

(72) Inventor: Kunio SODEYAMA, Kyoto (JP)

(21) Appl. No.: 18/402,367

(22) Filed: Jan. 2, 2024

Related U.S. Application Data
(63) Continuation of application No. PCT/JP2022/027705, filed on Jul. 14, 2022.

(30) Foreign Application Priority Data
Jul. 21, 2021 (JP) 2021-120579

(51) Int. Cl. H01M 50/578; H01M 10/04; H01M 50/586; H01M 50/591

(52) U.S. Cl. CPC H01M 50/578; H01M 10/0422; H01M 50/586; H01M 50/591; H01M 2200/20

(57) ABSTRACT

A cylindrical battery is provided and includes a columnar electrode body, a cylindrical battery can in which one end portion is opened and the electrode body is accommodated, and a current interrupt device provided at the one end portion. The current interrupt device includes a cover, a holder provided inside the cover, and a disk provided inside the holder.

### CROSS REFERENCE TO RELATED APPLICATIONS

The present application is a continuation of PCT patent application no. PCT/JP2022/027705, filed on Jul. 14, 2022, which claims priority to Japanese patent application no. 2021-120579, filed on Jul. 21, 2021, the entire contents of which are incorporated herein by reference.

### BACKGROUND

The present application relates to a cylindrical battery.

Conventionally, a cylindrical battery includes a current interrupt device (CID) capable of disconnecting an electrical connection between a battery lid and an electrode body in a case where the battery is in an abnormal state. For example, a cylindrical battery is disclosed including a current interrupt device in which a safety cover, a stripper disk, and a disk holder are combined, in which a contact portion formed to protrude is provided at a center portion of the safety cover, and the contact portion and a positive electrode lead are electrically connected.

### SUMMARY

The present application relates to a cylindrical battery.

However, in the battery described in the Background section, there is a problem that a connection portion between the contact portion and the positive electrode lead is susceptible to fatigue fracture due to vibration, and thus reliability is deteriorated.

The present application, in an embodiment, relates to providing a cylindrical battery capable of improving reliability against vibration.

In an embodiment, a cylindrical battery is provided and including:
a columnar electrode body;
a cylindrical battery can in which one end portion is opened and the electrode body is accommodated; and
a current interrupt device provided at the one end portion,
in which the current interrupt device includes a cover, a holder provided inside the cover, and a disk provided inside the holder,
the cover includes:
   a first protrusion including a first bottom portion and an annular first side wall portion raised in a direction away from the electrode body from a peripheral edge of the first bottom portion; and
   a first flange portion extending outward from an upper end of the first side wall portion,
the holder includes:
   a first accommodation portion including an annular second side wall portion raised from an extension portion in a direction away from the electrode body, and the extension portion extending inward from a lower end of the second side wall portion; and
   a second flange portion extending outward from an upper end of the first side wall portion,
the disk includes:
   a second accommodation portion including a second bottom portion including a second protrusion protruding from a central portion toward the first bottom portion, and an annular third side wall portion raised in a direction away from the electrode body from a peripheral edge of the second bottom portion; and
   a third flange portion extending outward from an upper end of the third side wall portion,
the first protrusion of the cover is fitted into the first accommodation portion of the holder,
the first accommodation portion of the holder is fitted into the second accommodation portion of the disk, and
a top portion of the second protrusion is connected to the first bottom portion by welding.

According to the present technology, in an embodiment, reliability of a cylindrical battery can be improved.

### BRIEF DESCRIPTION OF THE FIGURES

FIG. 1 is a sectional view illustrating an example of a configuration of a cylindrical non-aqueous electrolyte secondary battery according to an embodiment of the present application.

FIG. 2 is an enlarged sectional view illustrating a part of FIG. 1.

FIG. 3 is an exploded perspective view illustrating an example of a configuration of a current interrupt device.

FIG. 4 is an exploded sectional view illustrating an example of a configuration of a current interrupt device.

FIG. 5 is an enlarged sectional view illustrating a part of FIG. 2.

FIG. 6 includes views A to C which are plan views for explaining a method of measuring a thickness of a top portion of a protrusion.

FIG. 7 is a sectional view for explaining a method of measuring the thickness of the top portion of the protrusion.

FIG. 8 is a sectional view illustrating an example of a configuration of a positive electrode and a negative electrode.

FIG. 9 is a sectional view illustrating an example of a configuration of a current interrupt device according to an embodiment of the present application.

FIG. 10 is a sectional view illustrating an example of a configuration of a current interrupt device according to an embodiment of the present application.

FIG. 11, view A is a sectional view illustrating an example of a configuration of a current interrupt device according to an embodiment. FIG. 11, view B is an enlarged sectional view illustrating a part of FIG. 11, view A.

FIG. 12 is a block diagram illustrating an example of a configuration of an electronic device according to another embodiment of the present application.

FIG. 13 is a sectional view illustrating a configuration of a current interrupt device used in Comparative Example 1.

FIG. 14 is an exploded perspective view illustrating a configuration of the current interrupt device used in Comparative Example 1.

FIG. 15 is a sectional view illustrating a configuration of an interrupting pressure measurement device.

### DETAILED DESCRIPTION

The present application will be described below in further detail including with reference to the figures according to an embodiment.

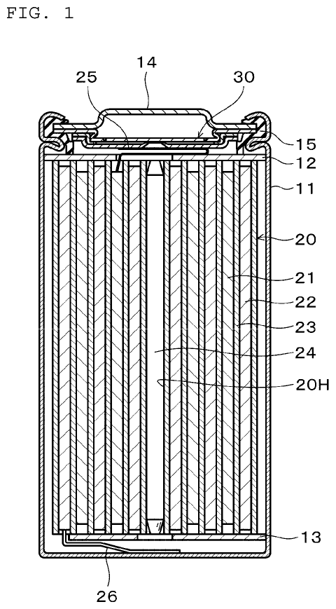

Hereinafter, an example of a configuration of a cylindrical non-aqueous electrolyte secondary battery (Hereinafter, it is referred to as a “battery”) according to an embodiment of the present application will be described with reference to FIG. 1. This battery is, for example, a general lithium ion secondary battery in which a capacitance of a negative electrode is represented by a capacitance component determined by occlusion and release of lithium (Li) as an electrode reactant. The battery includes a battery can 11, an electrode body 20, a pair of insulating plates 12 and 13, an electrolytic solution (not illustrated), a battery lid 14, a current interrupt device 30, and a sealing gasket 15.

The battery can 11 accommodates the electrode body 20. The battery can 11 has a cylindrical shape with one end portion closed and the other end portion opened. The battery can 11 is made of, for example, iron (Fe) plated with nickel (Ni).

The electrode body 20 is a so-called wound electrode body and has a substantially cylindrical shape. The electrode body 20 has a first end portion and a second end portion. The first end portion is an open end portion side of the battery can 11, and the second end portion is a bottom side of the battery can 11. The electrode body 20 has a center hole 20H penetrating from a center of the first end portion toward a center of the second end portion. A center pin 24 is inserted into the center hole 20H.

A positive electrode lead 25 is provided at the first end portion of the electrode body 20. The positive electrode lead 25 is electrically connected to the battery lid 14 by being welded to the current interrupt device 30. The positive electrode lead 25 is made of, for example, a metal material such as aluminum (Al). A negative electrode lead 26 is provided at the second end portion of the electrode body 20. The negative electrode lead 26 is welded and electrically connected to the battery can 11. The negative electrode lead 26 is made of, for example, a metal material such as nickel (Ni).

The insulating plate 12 covers the first end portion of the electrode body 20. The insulating plate 12 is disposed such that a principal surface of the insulating plate 12 is perpendicular to a height direction of the battery. The insulating plate 13 covers the second end portion of the electrode body 20. The insulating plate 13 is disposed such that a principal surface of the insulating plate 13 is perpendicular to the height direction of the battery. Note that the height direction of the battery is a vertical direction toward a paper surface of FIG. 1.

The battery lid 14 and the current interrupt device 30 are attached by crimping the open end portion of the battery can 11 with the sealing gasket 15 interposed between their peripheral edge portions and the open end portion of the battery can 11. The inside of the battery can 11 is thus hermitically sealed. The current interrupt device 30 is provided inside the battery lid 14. The battery lid 14 is made of, for example, the same material as that of the battery can 11.

The sealing gasket 15 is sandwiched between outer peripheral portions of the battery lid 14 and the current interrupt device 30 and the open end portion of the battery can 11. The sealing gasket 15 has an annular shape. The sealing gasket 15 is made of, for example, an insulating material, and has a surface coated with asphalt.

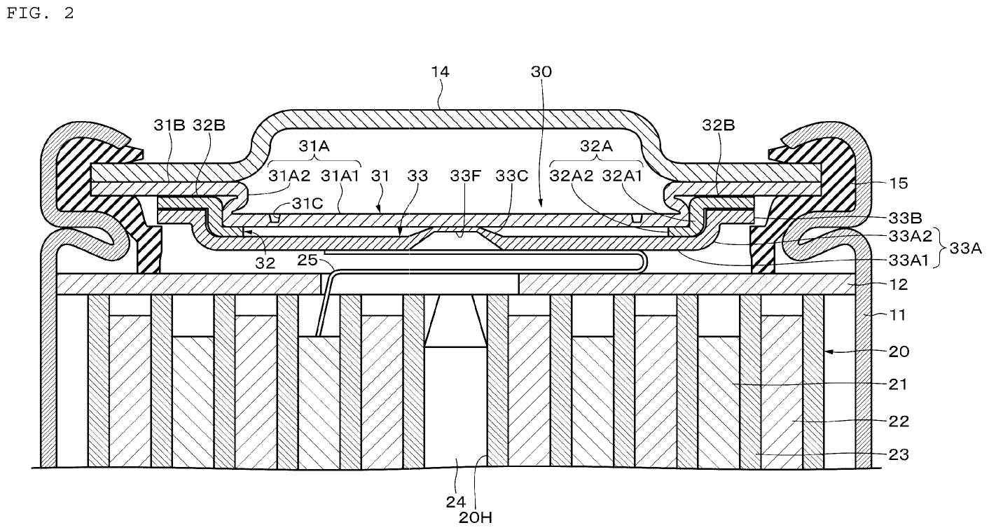

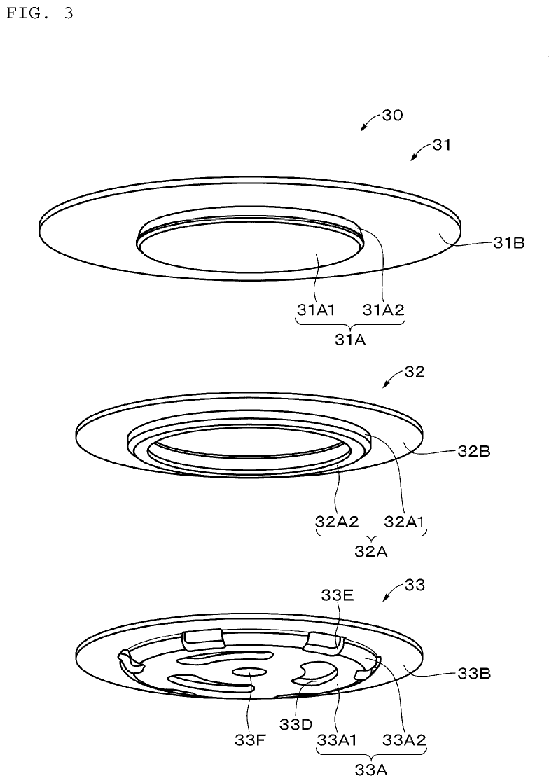

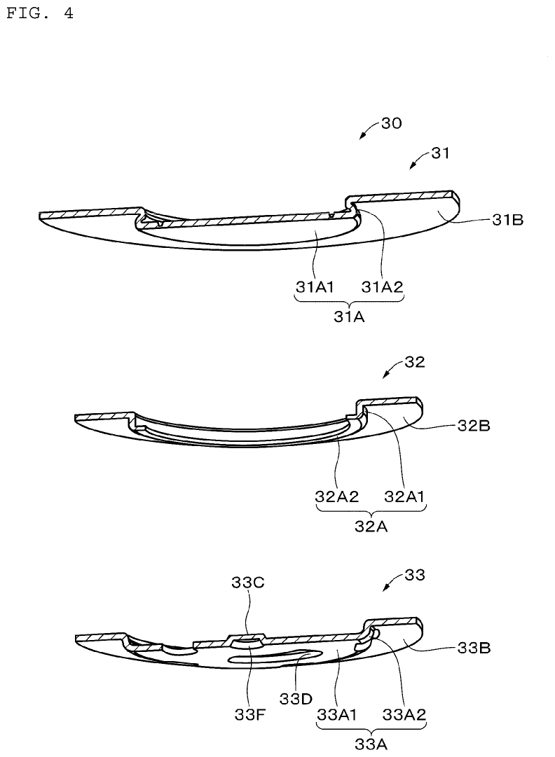

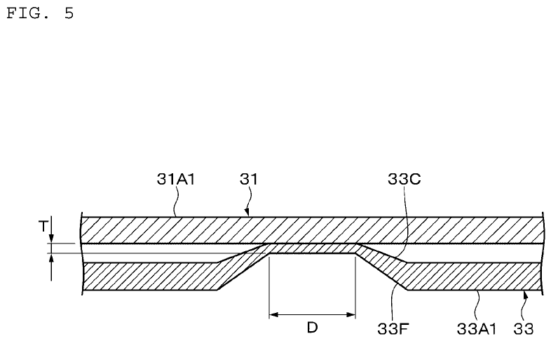

Hereinafter, the configuration of the current interrupt device 30 will be described with reference to FIGS. 2, 3, 4, and 5 according to an embodiment. The current interrupt device 30 includes a cover 31, a holder 32 provided inside the cover 31, and a disk 33 provided inside the holder 32. The current interrupt device 30 is electrically connected to the battery lid 14, and in a case where an internal pressure of the battery becomes higher than or equal to a certain level due to an internal short circuit, heating from the outside, or the like, the cover 31 as a safety valve is inverted, and the electrical connection between the battery lid 14 and the electrode body 20 can be disconnected.

The cover 31 can operate as a safety valve. The cover 31 is attached by crimping the open end portion of the battery can 11. The cover 31 holds the holder 32. The cover 31 is made of metal such as aluminum (Al). The cover 31 has a disk shape. The cover 31 has a first surface facing the disk 33 and a second surface opposite to the first surface and facing the battery lid 14. The cover 31 includes a first protrusion 31A and a first flange portion 31B.

The first protrusion 31A protrudes from the first flange portion 31B toward the first end portion of the electrode body 20. The first protrusion 31A includes a first bottom portion 31A1 and a first side wall portion 31A2. The first bottom portion 31A1 has a circular flat plate shape. The first bottom portion 31A1 is held so as to be perpendicular to the height direction of the battery.

A groove 31C is provided on the second surface of the first bottom portion 31A1. The groove 31C has an annular shape in plan view. A center of the annular shape is located on a central axis of the battery. The groove 31C is for adjusting a cleavage pressure of the cover 31. The cleavage pressure of the groove 31C is set to be higher than an operation pressure (That is, the pressure at which the cover 31 is reversed) of the current interrupt device 30. In a case where the internal pressure further increases when the current interrupt device 30 operates, the groove 31C is cleaved, so that a gas generated in the battery is released to the outside.

The first side wall portion 31A2 is raised in a direction away from the first end portion of the electrode body 20 from a peripheral edge of the first bottom portion 31A1. The first side wall portion 31A2 has an annular shape. The first side wall portion 31A2 is inclined such that an inner diameter of the first side wall portion 31A2 gradually increases from an upper portion to a lower portion. Therefore, the first side wall portion 31A2 of the cover 31 abuts on a second side wall portion 32A1 of the holder 32 described later, and the holder 32 is firmly fixed to the cover 31.

The first flange portion 31B extends outward from an upper end of the first side wall portion 31A2. The first flange portion 31B is in contact with a peripheral edge portion of the battery lid 14. The peripheral edge portions of the abutted first flange portion 31B and battery lid 14 are held by crimping the open end portion of the battery can 11 with the sealing gasket 15 interposed between their peripheral edge portions and the open end portion of the battery can 11.

The holder 32 holds the disk 33. The holder 32 separates and insulates the cover 31 and the disk 33. The holder 32 includes, for example, a synthetic polymer. The synthetic polymer preferably includes one or both of polybutylene terephthalate (PBT) and polyphenylene sulfide (PPS). In this regard, it is possible to suppress melting of the holder 32 in a case where the internal temperature of the battery rises due to an internal short circuit, heating from the outside, or the like. Therefore, contact and conduction between the cover 31 and the disk 33 can be suppressed. Thus, the durability of the current interrupt device 30 can be improved. In a case where the holder 32 includes two types of polybutylene terephthalate and polyphenylene sulfide, the holder 32 may be a two-color molded body formed of these two types of materials, or the holder 32 may be a molded body formed of a mixture of these two types of materials.

The holder 32 has an annular shape. The holder 32 includes a first accommodation portion 32A and a second flange portion 32B. The first protrusion 31A of the cover 31 is fitted into the first accommodation portion 32A of the holder 32. The first accommodation portion 32A includes the second side wall portion 32A1 and an extension portion 32A2. The second side wall portion 32A1 is raised in a direction away from the first end portion of the electrode body 20 from the extension portion 32A2. The second side wall portion 32A1 is configured to be parallel to the central axis of the battery. The second side wall portion 32A1 has an annular shape. An inner diameter of the second side wall portion 32A1 is set to be one size larger than a diameter of the first bottom portion 31A1 of the cover 31, and the second side wall portion 32A1 can fit the first protrusion 31A of the cover 31 inside.

The extension portion 32A2 extends inward from a lower end of the second side wall portion 32A1 so as to be orthogonal to the central axis of the battery. The extension portion 32A2 is in contact with the first bottom portion 31A1. The second flange portion 32B extends outward from an upper end of the second side wall portion 32A1. The second flange portion 32B is in contact with the first flange portion 31B.

The disk 33 electrically connects the cover 31 and the positive electrode lead 25. The disk 33 has a disk shape. The disk 33 is made of metal such as aluminum (Al). The disk 33 includes a first surface facing the first end portion of the electrode body 20 and a second surface facing the cover 31. The positive electrode lead 25 abuts on the first surface of the disk 33 and is laser-welded. The disk 33 includes a second accommodation portion 33A and a third flange portion 33B. The first accommodation portion 32A of the holder 32 is fitted into the second accommodation portion 33A of the disk 33. The second accommodation portion 33A includes a second bottom portion 33A1 and a third side wall portion 33A2.

The second bottom portion 33A1 has a circular shape in plan view. The second bottom portion 33A1 is held so as to be perpendicular to the height direction of the battery. The second bottom portion 33A1 includes a second protrusion 33C. The second protrusion 33C protrudes from a central portion of the second bottom portion 33A1 toward the first bottom portion 31A1. The second protrusion 33C has, for example, a truncated cone shape. The second bottom portion 33A1 is in contact with the extension portion 32A2 of the holder 32. The first bottom portion 31A1 of the cover 31 and the second bottom portion 33A1 of the disk 33 are separated by the extension portion 32A2.

A top portion of the second protrusion 33C is connected to the first bottom portion 31A1 of the cover 31 by welding. The welding is preferably ultrasonic welding. A back surface side of the second protrusion 33C is provided with a recess 33F depressed in a direction away from the first end portion of the electrode body 20. A bottom portion of the recess 33F has a circular shape in plan view. A thickness T of the top portion of the second protrusion 33C is thinner than a thickness of the other portions which are portions other than the top portion of the second protrusion 33C. As a result, welding strength by ultrasonic welding can be increased, so that reliability against vibration can be improved. The top portion of the second protrusion 33C has a circular shape in plan view.

The third side wall portion 33A2 is raised in a direction away from the first end portion of the electrode body 20 from a peripheral edge of the second bottom portion 33A1. The third side wall portion 33A2 has an annular shape. Between the second bottom portion 33A1 and the third side wall portion 33A2 may be curved such that the second surface of the disk 33 is concave. An inner diameter of the third side wall portion 33A2 is set to be one size larger than an outer diameter of the second side wall portion 32A1 of the holder 32, and the second side wall portion 32A1 of the holder 32 can be fitted inside the third side wall portion 33A2. The third flange portion 33B extends outward from an upper end of the third side wall portion 33A2. The third flange portion 33B is in contact with the second flange portion 32B.

The disk 33 includes a plurality of through holes 33D and a plurality of through holes 33E. The plurality of through holes 33D are provided in the second bottom portion 33A1. The plurality of through holes 33D are disposed at equal intervals on the same circumference centered on the second protrusion 33C. The plurality of through holes 33E are provided in the third side wall portion 33A2. The plurality of through holes 33E are disposed at equal intervals on the same circumference centered on the second protrusion 33C.

The thickness T of the top portion of the second protrusion 33C is preferably 0.05 mm or more and 0.20 mm or less. When the thickness T of the top portion of the second protrusion 33C is 0.05 mm or more, a decrease in strength of the welded portion is suppressed, so that occurrence of fatigue fracture in the welded portion is suppressed in a case where vibration is applied to the battery. As a result, the welded portion is hardly detached, and the reliability of the battery against vibration can be improved. On the other hand, when the thickness T of the top portion of the second protrusion 33C is 0.20 mm or less, it is not necessary to excessively increase the strength of the ultrasonic welding in order to maintain the strength of the welded portion, so that it is possible to suppress a welding range from expanding to the cover 31 and to suppress weakening of the welded portion. Therefore, since it is possible to suppress formation of a hole in the cover 31 due to an impact such as dropping, it is possible to suppress occurrence of liquid leakage of the electrolytic solution. Thus, the reliability of the battery against impact such as dropping can be improved.

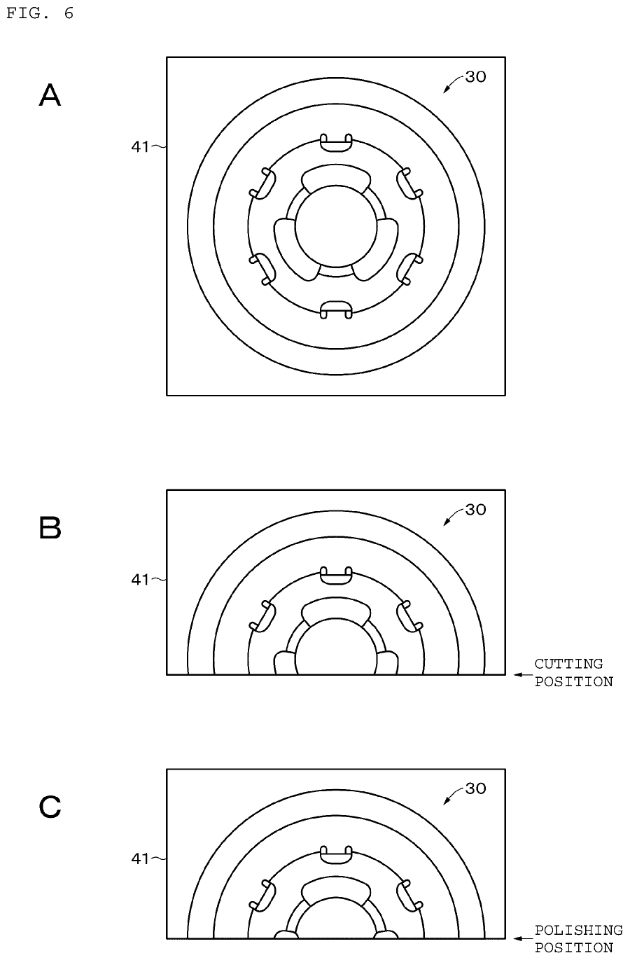

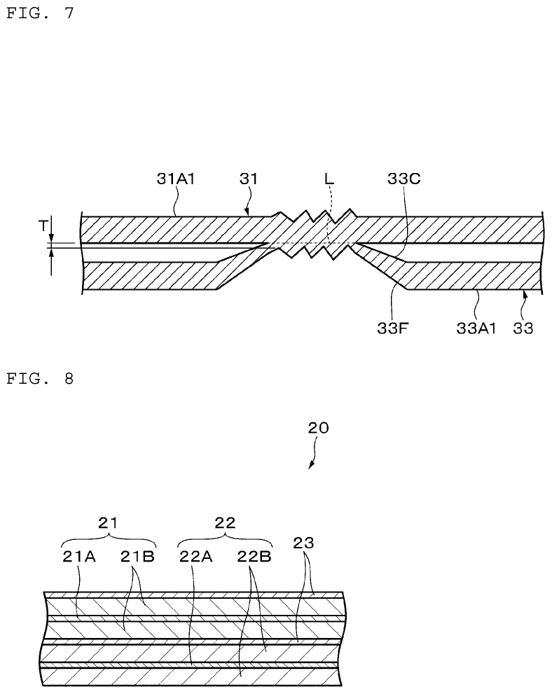

The thickness T of the top portion of the second protrusion 33C is obtained as follows. First, the battery is disassembled, and the current interrupt device 30 is taken out. Next, the current interrupt device 30 is accommodated in a cup 41, and an epoxy resin is supplied into the cup 41 and solidified to prepare a measurement sample (see FIG. 6A). Next, the measurement sample is cut to a position before the center of the current interrupt device 30 by a cutting machine (see FIG. 6B). Next, the measurement sample is polished to the center of the current interrupt device 30 (see FIG. 6C). Next, the thickness T of the top portion of the second protrusion 33C of the disk 33 is measured as follows using a tool microscope (see FIG. 7). That is, in the field of view of the tool microscope, a virtual line L is drawn at an interface between the top portion of the second protrusion 33C of the disk 33 and the first surface of the cover 31, a thickness of the thinnest portion in thicknesses of the top portion of the second protrusion 33C is read, and this is defined as the thickness T of the top portion of the second protrusion 33C of the disk 33.

As described above, the recess 33F is provided on the back surface side of the second protrusion 33C. A size (diameter) D of the bottom portion of the recess 33F is preferably 0.5 mm or more and 3.0 mm or less. When the size D of the bottom portion of the recess 33F is 0.5 mm or more, a decrease in strength of the welded portion can be suppressed, so that occurrence of fatigue fracture in the welded portion is suppressed in a case where vibration is applied to the battery. As a result, cracks are less likely to occur in the welded portion, and the reliability of the battery against vibration can be improved. On the other hand, when the size D of the bottom portion of the recess 33F is 3.0 mm or less, a decrease in strength of the disk 33 is suppressed, so that it is possible to suppress variation in the interrupting pressure of the current interrupt device 30.

A size R of the top portion of the second protrusion 33C is obtained as follows. A cross section of the current interrupt device 30 is cut out in accordance with the procedure of the method of measuring the thickness T of the top portion of the second protrusion 33C. Next, the size (diameter) D of the bottom portion of the recess 33F of the disk 33 is measured using a tool microscope.

Note that, in a case where there is distortion in the shape (circular shape) of the bottom portion of the recess 33F and the size of the bottom portion of the recess 33F differs depending on a sectional direction, the bottom portion of the recess 33F is measured in a cross section in which the size of the bottom portion of the recess 33F is maximized.

The electrode body 20 includes a strip-shaped positive electrode 21, a strip-shaped negative electrode 22, and a strip-shaped separator 23. The separator 23 is sandwiched between the positive electrode 21 and the negative electrode 22. The positive electrode 21, the negative electrode 22, and the separator 23 are wound in a longitudinal direction. The positive electrode lead 25 is connected to the positive electrode 21. The negative electrode lead 26 is connected to the negative electrode 22.

Hereinafter, the positive electrode 21, the negative electrode 22, the separator 23, and the electrolytic solution constituting the battery will be sequentially described.

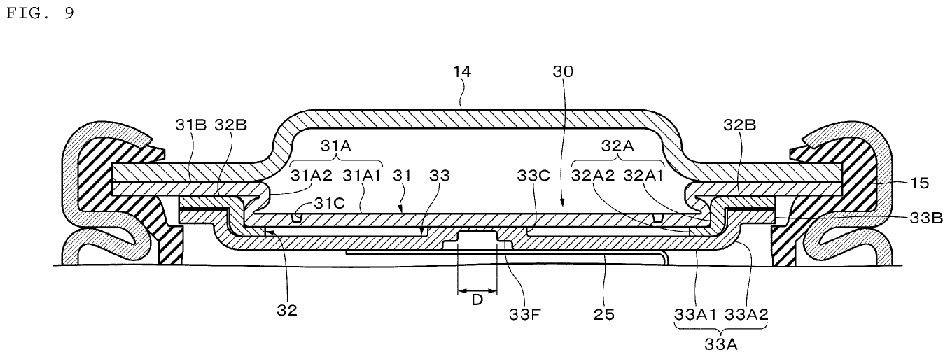

As illustrated in FIG. 8, the positive electrode 21 includes a positive electrode current collector 21A and positive electrode active material layers 21B provided on both sides of the positive electrode current collector 21A. The positive electrode current collector 21A is made of, for example, a metal foil such as an aluminum foil, a nickel foil, or a stainless-steel foil. The positive electrode current collector 21A may have a plate shape or a mesh shape. The positive electrode 21 includes a positive electrode current collector exposed portion where the positive electrode current collector 21A is exposed without being covered with the positive electrode active material layer 21B. The positive electrode lead 25 is connected to the positive electrode current collector exposed portion.

The positive electrode active material layer 21B includes one type of, or two or more types of positive electrode active materials capable of occluding and releasing lithium. The positive electrode active material layer 21B may further contain at least one selected from the group consisting of a binder and a conductive auxiliary if necessary.

As the positive electrode active material capable of occluding and releasing lithium, a lithium-containing compound, for example, lithium oxide, lithium phosphorus oxide, lithium sulfide, or an intercalation compound containing lithium is suitable, and two or more of these may be used in mixture. For increasing the energy density, a lithium-containing compound containing lithium, a transition metal element, and oxygen is preferred.

As illustrated in FIG. 8, the negative electrode 22 includes a negative electrode current collector 22A and negative electrode active material layers 22B provided on both sides of the negative electrode current collector 22A. The negative electrode current collector 22A is made of, for example, a metal foil such as a copper foil, a nickel foil, or a stainless-steel foil. The negative electrode current collector 22A may have a plate shape or a mesh shape. The negative electrode 22 includes a negative electrode current collector exposed portion where the negative electrode current collector 22A is exposed without being covered with the negative electrode active material layer 22B. The negative electrode lead 26 is connected to the negative electrode current collector exposed portion.

The negative electrode active material layer 22B includes one type of, or two or more types of negative electrode active materials capable of occluding and releasing lithium. The negative electrode active material layer 22B may further contain at least one selected from the group consisting of a thickener and a conductive auxiliary if necessary.

Examples of the negative electrode active material include carbon materials such as non-graphitizable carbon, graphitizable carbon, graphite, pyrolytic carbons, cokes, glassy carbons, fired products of organic polymer compounds, carbon fibers, and activated carbon. Furthermore, examples of other negative electrode active materials capable of increasing the capacitance include materials containing, as a constituent element (for example, an alloy, a compound, or a mixture), at least one selected from the group consisting of metal elements and metalloid elements.

The separator 23 is intended to separate the positive electrode 21 and the negative electrode 22 from each other, thereby preventing a short circuit due to contact between the both electrodes, and at the same time, allowing lithium ions to pass through the separator 23. The separator 23 is, for example, a porous film. The separator 23 may be a laminated film in which two or more kinds of porous films are laminated.

The porous film includes, for example, at least one selected from the group consisting of polytetrafluoroethylene, a polyolefin resin (polypropylene (PP), polyethylene (PE), or the like), an acrylic resin, a styrene resin, a polyester resin, and a nylon resin. In an embodiment, a porous membrane made of a polyolefin is preferred so as to provide an enhanced effect of preventing short circuits and allowing the safety of the battery to be improved by the shutdown effect.

The separator 23 may be made of a nonwoven fabric. As fibers constituting the nonwoven fabric, aramid fibers, glass fibers, polyolefin fibers, polyethylene terephthalate (PET) fibers, nylon fibers, and the like can be used. Alternatively, two or more of these fibers may be mixed to form the nonwoven fabric.

The electrolytic solution is accommodated in the battery can 11. The positive electrodes 21, the negative electrodes 22, and the separators 23 are impregnated with the electrolytic solution. The electrolytic solution, which is a so-called non-aqueous electrolytic solution, includes a non-aqueous solvent (organic solvent) and an electrolyte salt dissolved in the non-aqueous solvent. The electrolytic solution may include a known additive to improve battery characteristics.

As the organic solvent, cyclic carbonic acid esters such as an ethylene carbonate and a propylene carbonate can be used, and one of an ethylene carbonate and a propylene carbonate, particularly both thereof are preferably used in mixture. Examples of the electrolyte salt include lithium salts, and the lithium salts may be used singly or in mixture of two or more kinds thereof.

Next, an example of a method of manufacturing the battery according to an embodiment of the present application will be described.

The electrode body 20 is produced as follows. First, for example, a positive electrode mixture is prepared by mixing a positive electrode active material, a conductive agent, and a binder, and this positive electrode mixture is dispersed in a solvent such as N-methyl-2-pyrrolidone (NMP) to prepare a paste-like positive electrode mixture slurry. Then, this positive electrode mixture slurry is applied to both surfaces of the positive electrode current collector 21A, the solvent is dried, and compression molding is performed with, for example, a roll press machine to form the positive electrode active material layer 21B, thereby providing the positive electrode 21. At this time, the positive electrode current collector exposed portion is formed on the positive electrode 21.

Furthermore, for example, a negative electrode mixture is prepared by mixing a negative electrode active material and a binder, and the negative electrode mixture is dispersed in a solvent such as N-methyl-2-pyrrolidone to prepare a paste-like negative electrode mixture slurry. Then, this negative electrode mixture slurry is applied to both surfaces of the negative electrode current collector 22A, the solvent is dried, and compression molding is performed with, for example, a roll press machine to form the negative electrode active material layer 22B, thereby providing the negative electrode 22. At this time, the negative electrode current collector exposed portion is formed on the negative electrode 22.

Next, the positive electrode lead 25 is attached to the positive electrode current collector exposed portion by welding or the like, and the negative electrode lead 26 is attached to the negative electrode current collector exposed portion by welding or the like. Next, the positive electrode 21 and the negative electrode 22 are wound with the separator 23 interposed therebetween to obtain the electrode body 20.

The current interrupt device 30 is assembled as follows. The current interrupt device 30 is assembled by press-fitting the first protrusion 31A of the cover 31 into the first accommodation portion 32A of the holder 32 and press-fitting the first accommodation portion 32A of the holder 32 into the second accommodation portion 33A of the disk 33. The top portion of the second protrusion 33C of the disk 33 and the first bottom portion 31A1 of the cover 31 are ultrasonically welded.

The battery is assembled as follows. First, the electrode body 20 is sandwiched between the pair of insulating plates 12 and 13, the electrode body 20 is accommodated in the battery can 11, and the negative electrode lead 26 is welded to the battery can 11. Furthermore, the positive electrode lead 25 is brought into contact with the second bottom portion 33A1 of the disk 33.

Next, an electrolytic solution is injected into the battery can 11 in which the electrode body 20 is accommodated. Next, the current interrupt device 30 and the battery lid 14 are fixed by crimping the open end portion of the battery can 11 while sandwiching the sealing gasket 15 between the peripheral edge portions of the current interrupt device 30 and the battery lid 14 and the open end portion of the battery can 11. As a result, the battery illustrated in FIG. 1 is obtained.

The battery according to an embodiment includes the current interrupt device 30 including the cover 31, the holder 32 provided inside the cover 31, and the disk 33 provided inside the holder 32. The disk 33 includes the second protrusion 33C protruding from the central portion of the second bottom portion 33A1 toward the first bottom portion 31A1 of the cover 31, and the top portion of the second protrusion 33C is connected to the first bottom portion 31A1 of the cover 31 by welding. The positive electrode lead 25 is in contact with the second bottom portion 33A1 of the disk 33. As a result, the welded portion between the top portion of the second protrusion 33C and the first bottom portion 31A1 of the cover 31 can be separated from the positive electrode lead 25. Therefore, since the welded portion is less likely to cause fatigue fracture due to vibration, the reliability of the battery against vibration can be improved.

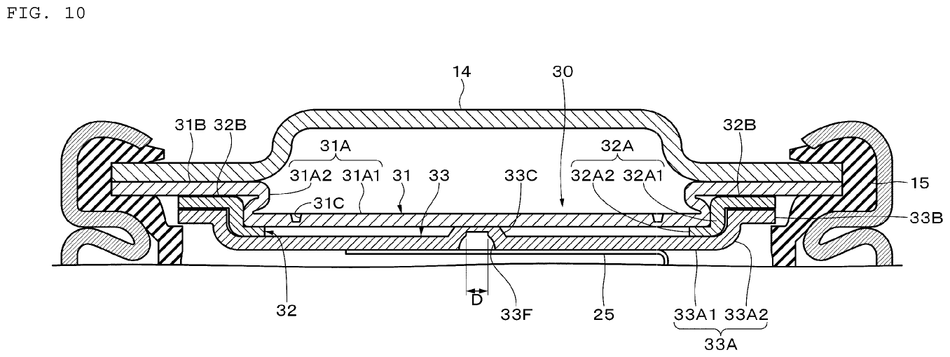

In an embodiment, an example in which the second protrusion 33C has a truncated cone shape (see FIG. 2) has been described, but the shape of the second protrusion 33C is not limited thereto. For example, the second protrusion 33C may have a columnar shape as illustrated in FIG. 9. In this case, a step may be provided in the recess 33F on the back surface side of the second protrusion 33C.

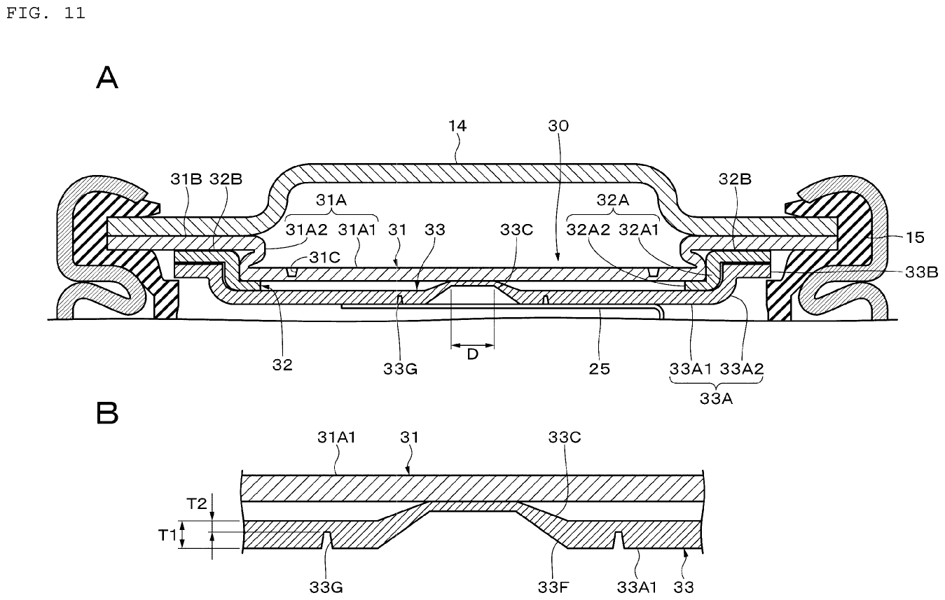

Furthermore, the second protrusion 33C may have a dome shape as illustrated in FIG. 10.

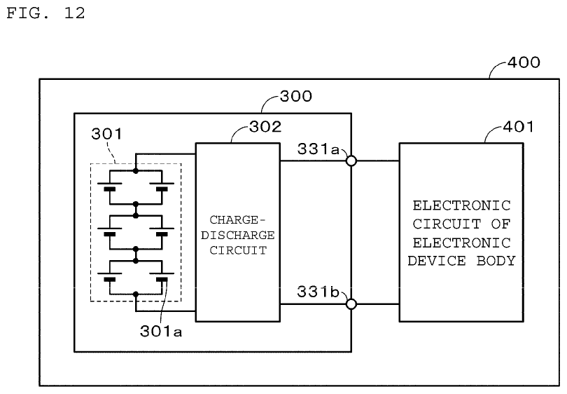

As illustrated in FIG. 11, views A and B, the second bottom portion 33A1 may include an annular groove 33G surrounding the second protrusion 33C on the first surface. Note that the second bottom portion 33A1 may include the groove 33G on the second surface. Since the second bottom portion 33A1 includes the groove 33G, the groove 33G can be easily broken in a case where the internal pressure of the battery becomes higher than or equal to a certain level due to an internal short circuit, heating from the outside, or the like. As a result, the first bottom portion 31A1 of the cover 31 can be easily inverted. Therefore, the operation of the current interrupt device 30 is facilitated.

A ratio R (=(T2/T1)×100) (Hereinafter, it is referred to as a “groove thickness ratio R”) of a bottom thickness T2 of the groove 33G to a thickness T1 of the disk 33 is preferably 30% or more and 70% or less. Here, the thickness T1 of the disk 33 refers to a thickness of the disk 33 in a portion excluding local unevenness such as the groove 33G. When the groove thickness ratio R is 30% or more, it is possible to suppress an increase in variation in the interrupting pressure of the current interrupt device 30 due to fatigue of the groove 33G in a case where vibration is applied to the battery. On the other hand, when the groove thickness ratio R is 70% or less, it is possible to suppress an increase in pressure for breaking the groove 33G when the current interrupt device 30 is interrupted (operated). Therefore, it is possible to suppress an increase in variation in the interrupting pressure of the current interrupt device 30.

The battery may further include a positive temperature coefficient element (PTC element) according to an embodiment. The positive temperature coefficient element has a ring shape, and is provided between the peripheral edge portion of the battery lid 14 and the peripheral edge portion of the cover 31.

An electronic device including a battery described herein according to an embodiment will be described.

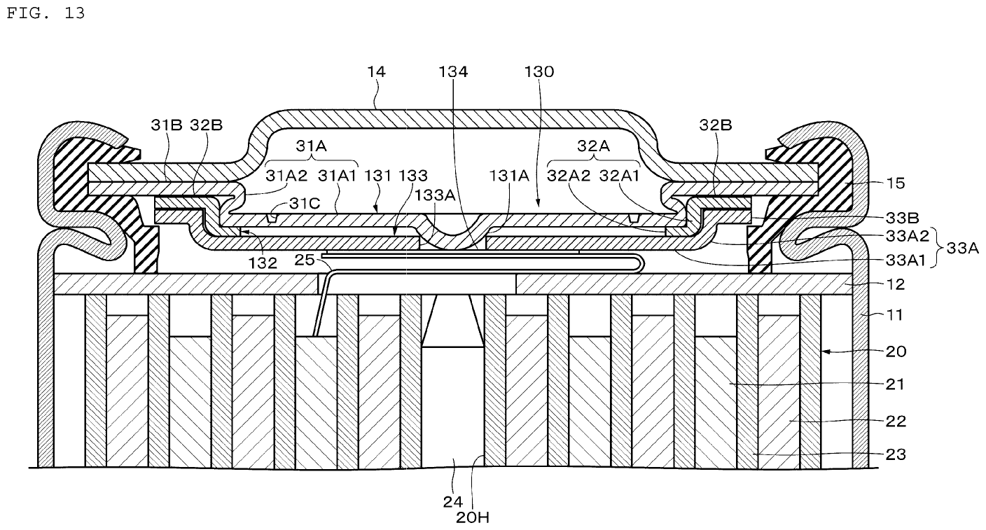

FIG. 12 illustrates an example of a configuration of an electronic device 400 according to an embodiment of the present application. The electronic device 400 includes an electronic circuit 401 of an electronic device body, and a battery pack 300. The battery pack 300 is electrically connected to the electronic circuit 401 with a positive electrode terminal 331a and a negative electrode terminal 331b interposed therebetween. The electronic device 400 may have a configuration in which the battery pack 300 is detachable.

Examples of the electronic device 400 include notebook personal computers, tablet computers, mobile phones (for example, smartphones), personal digital assistants (PDA), display devices (liquid crystal display (LCD), electro luminescence (EL) display, electronic paper and the like), imaging devices (for example, digital still cameras, digital video cameras and the like), audio devices (for example, portable audio players), game devices, cordless phone handsets, electronic books, electronic dictionaries, radios, headphones, navigation systems, memory cards, pacemakers, hearing aids, electric power tools, electric shavers, refrigerators, air conditioners, televisions, stereos, water heaters, microwave ovens, dishwashers, washing machines, dryers, lighting devices, toys, medical devices, and robots, but the electronic device 400 is not limited thereto.

The electronic circuit 401 includes, for example, a central processing unit (CPU), a peripheral logic unit, an interface unit, and a storage unit, and controls the overall electronic device 400.

The battery pack 300 includes an assembled battery 301 and a charge-discharge circuit 302. The battery pack 300 may further include an exterior material (not illustrated) that houses the assembled battery 301 and the charge-discharge circuit 302, if necessary.

The assembled battery 301 is composed of a plurality of secondary batteries 301a connected in series and/or in parallel. The plurality of secondary batteries 301a are connected, for example, in n parallel and m series (n and m are positive integers). Note that FIG. 12 illustrates an example in which six secondary batteries 301a are connected in 2 parallel 3 series (2P3S). As the secondary battery 301a, the battery according to the first embodiment is used.

While case in which the battery pack 300 includes the assembled battery 301 composed of the plurality of secondary batteries 301a will be described, a configuration in which the battery pack 300 includes one secondary battery 301a instead of the assembled battery 301 may be employed.

The charge-discharge circuit 302 is a control unit that controls charging and discharging the assembled battery 301. Specifically, at the time of charging, the charge-discharge circuit 302 controls charging the assembled battery 301. In contrast, at the time of discharging (that is, during the use of the electronic device 400), the charge-discharge circuit 302 controls discharging the electronic device 400.

A case made of, for example, a metal, a polymer resin, or a composite material thereof can be used as the exterior material. Examples of the composite material include a laminate that has a metal layer and a polymer resin layer laminated.

### EXAMPLES

Hereinafter, the present application will be described in further detail including with reference to examples according to an embodiment.

In the following examples and comparative examples, the same or corresponding parts as those of the battery described herein are denoted by the same reference symbols.

In the following examples and comparative examples, the thickness T of the top portion of the second protrusion 33C, the diameter D of the bottom portion of the recess 33F, and the groove thickness ratio R are values obtained by the measurement method described in the first embodiment.

### Example 1

### (Step of Producing Electrode Body)

The electrode body 20 was produced as follows. First, the positive electrode lead 25 was attached to the positive electrode current collector exposed portion of the positive electrode 21 by welding, and the negative electrode lead 26 was attached to the negative electrode current collector exposed portion of the negative electrode 22 by welding. Next, the positive electrode 21 and the negative electrode 22 were wound with the separator 23 interposed therebetween to obtain the electrode body 20.

### (Assembly Step of Current Interrupt Device)

The current interrupt device 30 was assembled as follows. The current interrupt device 30 illustrated in FIG. 2 is assembled by press-fitting the first protrusion 31A of the cover 31 into the first accommodation portion 32A of the holder 32 and press-fitting the first accommodation portion 32A of the holder 32 into the second accommodation portion 33A of the disk 33. The top portion of the second protrusion 33C of the disk 33 and the first bottom portion 31A1 of the cover 31 were ultrasonically welded. The cover 31 and the disk 33 made of aluminum were used. As the holder 32, one made of PBT (polybutylene terephthalate) was used. The thickness T of the top portion of the second protrusion 33C was set to 0.10 mm, and the diameter D of the bottom portion of the recess 33F was set to 1.6 mm.

### (Battery Assembling Step)

The battery was assembled as follows. First, the electrode body 20 was sandwiched between the pair of insulating plates 12 and 13, the electrode body 20 was accommodated in the battery can 11, and the negative electrode lead 26 was welded to the battery can 11. Furthermore, the positive electrode lead 25 was brought into contact with the second bottom portion 33A1 of the disk 33.

Next, an electrolytic solution was injected into the battery can 11 accommodating the electrode body 20 described above. Next, the current interrupt device 30 and the battery lid 14 were fixed by crimping the open end portion of the battery can 11 while sandwiching the sealing gasket 15 between the peripheral edge portions of the current interrupt device 30 and the battery lid 14 and the open end portion of the battery can 11. As a result, a cylindrical lithium ion secondary battery having an outer diameter (diameter) of 21 mm and a height of 70 mm and illustrated in FIG. 1 was obtained.

### Examples 2 to 5

A cylindrical lithium ion secondary battery was obtained in the same manner as in Example 1 except that the thickness T of the top portion of the second protrusion 33C was set to 0.03 mm, 0.05 mm, 0.20 mm, and 0.25 mm as shown in Table 1.

### Examples 6 to 9

A cylindrical lithium ion secondary battery was obtained in the same manner as in Example 1 except that the diameter D of the bottom portion of the recess 33F was set to 0.4 mm, 0.5 mm, 3.0 mm, and 3.2 mm as shown in Table 1.

### Examples 10 to 13

Except that groove 33G surrounding the second protrusion 33C was formed on the first surface of disk 33, and the groove thickness ratio R was set to 20%, 30%, 70%, or 80% as shown in Table 1, the same procedure as in Example 1 was carried out to obtain a cylindrical lithium ion secondary battery.

### Comparative Example 1

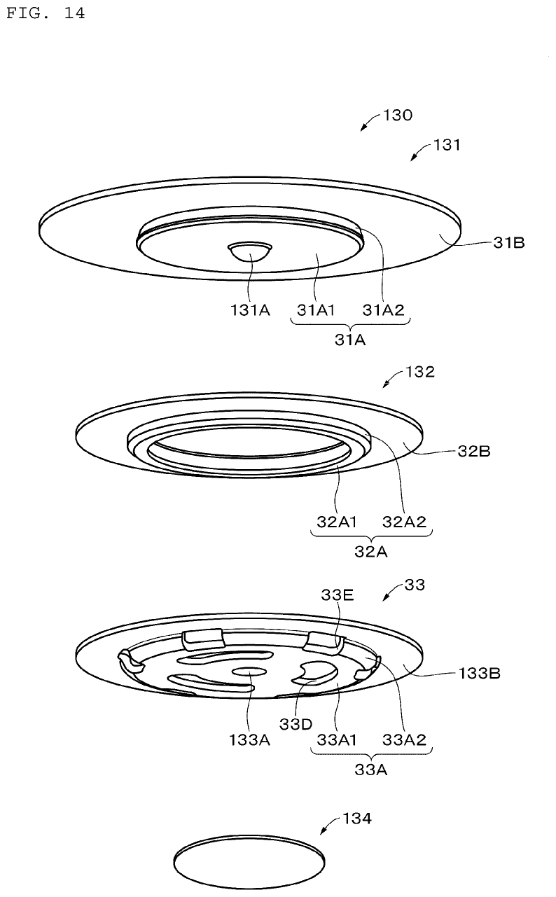

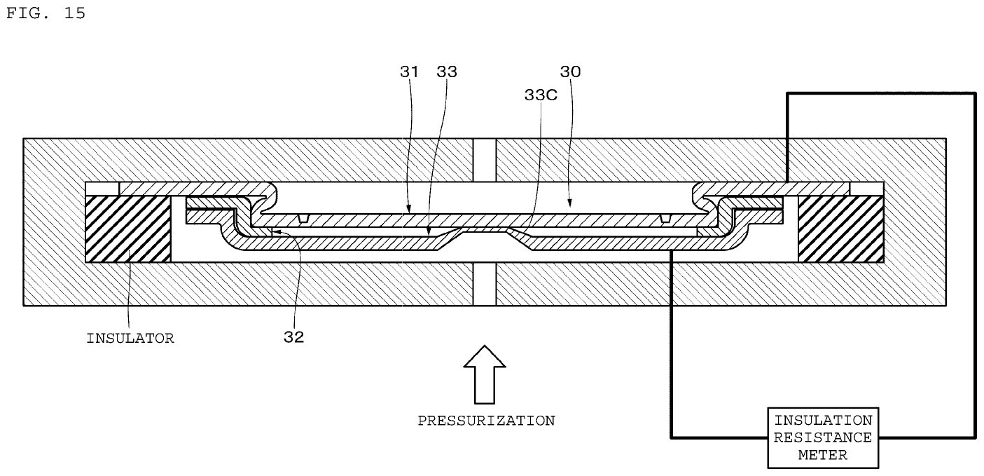

FIG. 13 is a sectional view illustrating a configuration of a current interrupt device 130 used in Comparative Example 1. FIG. 14 is an exploded perspective view illustrating a configuration of a current interrupt device 130 used in Comparative Example 1. In the current interrupt device 130 of Comparative Example 1, portions corresponding to those of the current interrupt device 30 of Example 1 are denoted by the same reference symbols.

The current interrupt device 130 includes a cover 131, a holder 132, a disk 133, and a sub disk 134. The cover 131 is similar to the cover 31 of Example 1 except that a protrusion 131A protruding toward the sub disk 134 is provided at a central portion of the first bottom portion 31A1. The holder 132 is similar to the holder 32 of Example 1. The disk 133 is similar to the disk 33 of Example 1 except that a through hole 133A is provided instead of the second protrusion 33C.

The sub disk 134 has a disk shape. The sub disk 134 is fixed to the second bottom portion 33A1 of the disk 133C by laser welding. The second surface of the sub disk 134 and the protrusion 131A of the cover 131 are connected by ultrasonic welding. Furthermore, the first surface of the sub disk 134 and the positive electrode lead 25 are connected by ultrasonic welding.

A cylindrical lithium ion secondary battery was obtained in the same manner as in Example 1 except that the current interrupt device 130 having the above configuration was used.

### (Vibration Test)

The 100 batteries obtained as above were subjected to a vibration test as follows. First, the battery was discharged to 2.5 V at a constant current of 4.0 A in an atmosphere of 23±2° C. Next, the test was carried out based on the vibration test conditions of the UN38.3 United Nations Recommendations on Transportation Test.

Specifically, the frequency from 7 Hz to 200 Hz to 7 Hz was swept for 15 minutes. The above sweep was repeated 12 times in each of three directions perpendicular to each other of the batteries.

For each battery, the AC resistance (1 kHz) was measured before the vibration test and after the vibration test, and a rate of increase in the AC resistance of the battery after the vibration test with respect to the AC resistance of the battery before the vibration test was calculated. The pass/fail of the vibration test was determined based on the calculated increase rate. Pass/fail determination criteria are as follows.

Pass: The resistance increase rate is less than 10%.

Fail: The resistance increase is 10% or more

The proportion (pass rate) of batteries that passed the vibration test among the prepared 100 batteries was calculated. The results are shown in Table 1.

### (Drop Test)

The 100 batteries obtained as above were subjected to a drop test as follows. First, a battery having a battery voltage of 4.4 V was dropped 100 times from a height of 10 m, and whether or not the electrolytic solution leaked from the inside of the battery to the outside was visually confirmed. Next, the pass/fail of the drop test was determined based on the results of the above confirmation. The determination criteria for the drop test are as follows.

Pass: Leakage of the electrolyte solution is not confirmed.

Fail: Leakage of the electrolyte solution is confirmed.

Among the prepared 100 batteries, the ratio (pass rate) of batteries that passed the drop test was calculated. The results are shown in Table 1.

### (Variation in Operating Pressure of Current Interrupt Device)

50 current interrupt devices 30 used in the battery of Examples 1 to 13 were prepared, and the safety valve operating pressure (interrupting pressure) was measured as follows. First, the current interrupt device 30 was set in an interrupting pressure measurement device illustrated in FIG. 15. Next, an insulation resistance meter was connected between the cover 31 and the disk 33 of the current interrupt device 30. Next, a side of the disk 33 was gradually pressurized by air, and a pressure value (interrupting pressure, kg/cm 2) at the time when the resistance value became infinite was read. Next, a standard deviation was calculated using the safety valve operating pressures of the 50 batteries measured as described above, and was defined as a variation in the operating pressure of the current interrupt device 30. The results are shown in Table 1.

The variation in operating pressure of the current interrupt device 130 used in the battery of Comparative Example 1 was also obtained in the same procedure as the current interrupt device 30. The results are shown in Table 1. However, when the safety valve operating pressure (interrupting pressure) of the current interrupt device 130 was measured, an insulation resistance meter was connected between the cover 131 and the sub disk 134 of the current interrupt device 130.

TABLE 1

| | Safety valve | | | | | | | | | | |
|---|---|---|---|---|---|---|---|---|---|---|---|
| | | | | Disk | | | | | | | Safety |
| | | | | | | Diameter | | | | | valve |
| | | | | | | D | Groove | | Vibration | Drop | operating |
| | Cover | Sub disk | | | Thickness T | [mm] of | | Groove | test | test | pressure |
| | Shape of | Presence | | Shape of | [mm] of top | bottom | Presence | thickness | pass | pass | standard |
| | welded | or | | welded | portion of | portion of | or | ratio R | rate | rate | deviation |
| | portion | absence | Shape | portion | protrusion | recess | absence | [%] | [%] | [%] | [kg/cm²] |
| Example 1 | Flat | Absent | — | Convex shape | 0.10 | 1.6 | Absent | — | 95 | 100 | 0.3 |
| Comparative | Convex | Present | Flat | Nothing | — | — | Absent | — | 80 | 100 | 0.3 |
| Example 1 | shape | | | | | | | | | | |
| Example 2 | Flat | Absent | — | Convex shape | 0.03 | 1.6 | Absent | — | 85 | 100 | 0.3 |
| Example 3 | Flat | Absent | — | Convex shape | 0.05 | 1.6 | Absent | — | 90 | 100 | 0.3 |
| Example 4 | Flat | Absent | — | Convex shape | 0.20 | 1.6 | Absent | — | 98 | 100 | 0.3 |
| Example 5 | Flat | Absent | — | Convex shape | 0.25 | 1.6 | Absent | — | 98 | 80 | 0.3 |
| Example 6 | Flat | Absent | — | Convex shape | 0.10 | 0.4 | Absent | — | 85 | 100 | 0.3 |
| Example 7 | Flat | Absent | — | Convex shape | 0.10 | 0.5 | Absent | — | 90 | 100 | 0.3 |
| Example 8 | Flat | Absent | — | Convex shape | 0.10 | 3.0 | Absent | — | 95 | 100 | 0.3 |
| Example 9 | Flat | Absent | — | Convex shape | 0.10 | 3.2 | Absent | — | 95 | 100 | 1.0 |
| Example 10 | Flat | Absent | — | Convex shape | 0.10 | 1.6 | Present | 20 | 95 | 100 | 1.0 |
| Example 11 | Flat | Absent | — | Convex shape | 0.10 | 1.6 | Present | 30 | 95 | 100 | 0.2 |
| Example 12 | Flat | Absent | — | Convex shape | 0.10 | 1.6 | Present | 70 | 95 | 100 | 0.2 |
| Example 13 | Flat | Absent | — | Convex shape | 0.10 | 1.6 | Present | 80 | 95 | 100 | 1.0 |

The following can be seen from Table 1.

In the battery in which the second protrusion 33C of the disk 33 is connected to the first bottom portion 31A1 of the cover 31 by ultrasonic welding, the pass rate of the vibration test can be 85% or more. Therefore, the reliability of the battery against vibration can be improved.

On the other hand, in the battery in which the protrusion 131C of the cover 131 is ultrasonically welded to the sub disk 134, the pass rate of the vibration test decreases to 80%. Therefore, the reliability of the battery against vibration is reduced.

When the thickness T of the top portion of the second protrusion 33C is 0.05 mm or more, the pass rate in the vibration test can be improved to 90% or more. When the thickness T of the top portion of the second protrusion 33C is 0.20 mm or less, the pass rate in the drop test can be 100%.

When the diameter D of the bottom portion of the recess 33F is 0.5 mm or more, the pass rate in the vibration test can be improved to 90% or more. When the diameter D of the bottom portion of the recess 33F is less than 3.0 mm, the variation in the operating pressure of the current interrupt device 30 can be suppressed to 0.3% or less.

When the groove thickness ratio R is 30% or more and 70% or less, the variation in the operating pressure of the current interrupt device 30 can be suppressed to 0.2% or less.

Although one or more embodiments of the present application have been described herein, the present application is not to be considered limited thereto, and thus various suitable modifications can be made.

For example, the configurations, methods, steps, shapes, materials, numerical values, and the like listed in the embodiments mentioned herein are considered by way of example only, and configurations, methods, steps, shapes, materials, numerical values, and the like that are different from the foregoing examples, may be used, if suitable and necessary.

The configurations, methods, steps, shapes, materials, and numerical values of the embodiments mentioned herein can be combined with each other in any suitable combination according to an embodiment.

In the numerical ranges described in stages in the embodiments mentioned herein, the upper limit or lower limit of the numerical range in a certain stage may be replaced with the upper limit value or lower limit of the numerical range in another stage.

Unless otherwise specified, one of the materials exemplified in the embodiments mentioned above may be used singly, or two or more thereof may be used in combination.

### DESCRIPTION OF REFERENCE SYMBOLS

11: Battery can
12, 13: Insulating version
14: Battery lid
15: Gasket
20: Electrode body
20H: Center hole
21: Positive electrode
21A: Positive electrode current collector
21B: Positive electrode active material layer
22: Negative electrode
22A: Negative electrode current collector
22B: Negative electrode active material layer
23: Separator
24: Center pin
25: Positive electrode lead
26: Negative electrode lead
30: Current interrupt device
31: Disk
32: Holder
33: Cover
31A: First protrusion
31A1: First bottom portion
31A2: First side wall portion
31B: First flange portion
32A: First accommodation portion
32A1: Second side wall portion
32A2: Extension portion
32B: Second flange portion
33A: Second accommodation portion
33A1: Second bottom portion
33A2: Second side wall portion
33B: Third flange portion
33C: Second protrusion
31C, 33G: Groove
31D, 31E: Through hole
33F: Recess

It should be understood that various changes and modifications to the embodiments described herein with be apparent to those skilled in the art. Such changes and modifications can be made without departing from the spirit and scope of the present subject matter and without diminishing its intended advantages. It is therefore intended that such changes and modifications be covered by the appended claims.

1. A cylindrical battery comprising:
a columnar electrode body;
a cylindrical battery can in which one end portion is opened and the electrode body is accommodated; and
a current interrupt device provided at the one end portion,
wherein the current interrupt device includes a cover, a holder provided inside the cover, and a disk provided inside the holder,
the cover includes:
a first protrusion including a first bottom portion and an annular first side wall portion raised in a direction away from the electrode body from a peripheral edge of the first bottom portion; and
a first flange portion extending outward from an upper end of the first side wall portion,
the holder includes:
a first accommodation portion including an annular second side wall portion raised from an extension portion in a direction away from the electrode body, and the extension portion extending inward from a lower end of the second side wall portion; and
a second flange portion extending outward from an upper end of the first side wall portion,
the disk includes:
a second accommodation portion including a second bottom portion including a second protrusion protruding from a central portion toward the first bottom portion, and an annular third side wall portion raised in a direction away from the electrode body from a peripheral edge of the second bottom portion; and
a third flange portion extending outward from an upper end of the third side wall portion,
the first protrusion of the cover is fitted into the first accommodation portion of the holder,
the first accommodation portion of the holder is fitted into the second accommodation portion of the disk, and
a top portion of the second protrusion is connected to the first bottom portion by welding.

2. The cylindrical battery according to claim 1, wherein a thickness of the top portion of the second protrusion is less than a thickness of a non-top portion of the second protrusion.

3. The cylindrical battery according to claim 1, wherein a thickness of the top portion of the second protrusion is 0.05 mm or more and 0.20 mm or less.

4. The cylindrical battery according to claim 1, wherein
a recess is provided on a back surface side of the second protrusion, and
a size of a bottom portion of the recess is 0.5 mm or more and 3.0 mm or less.

5. The cylindrical battery according to claim 1, wherein
the second bottom portion includes an annular groove surrounding the second protrusion, and
a ratio of a bottom thickness of the groove to a thickness of the disk is 30% or more and 70% or less.

6. The cylindrical battery according to claim 1, wherein the first side wall portion is inclined such that an inner diameter of the first side wall portion gradually increases from an upper portion to a lower portion.
